(19) United States
(12) Patent Application Publication
(10) Pub. No.: US 2015/0269644 A1
(43) Pub. Date: Sep. 24, 2015

(54) ELECTRONIC CONCIERGE

(71) Applicants: Peter Morrison, Lumberton, TX (US); Tom Owens, Lumberton, TX (US); Enoch Morrison, Lumberton, TX (US)

(72) Inventors: Peter Morrison, Lumberton, TX (US); Tom Owens, Lumberton, TX (US); Enoch Morrison, Lumberton, TX (US)

(21) Appl. No.: 14/220,124

(22) Filed: Mar. 19, 2014

(51) Int. Cl. G06Q 30/06; G06F 17/30; H04L 29/08

(52) U.S. Cl. CPC G06Q 30/0625; H04L 67/306; G06F 17/30386; G06Q 30/0633

(57) ABSTRACT

This disclosed method and system allows a user to identify a specific item or service when supplied with a generic name for an item of service. By using different processes, including keyword processing, the method and system can identify a specific item or service with a minimal amount of user input, saving the user time.

### BACKGROUND

Consumers currently face an almost overwhelming array of choices when it comes to goods and service providers. Consumers know they have a need, but may not be able to properly articulate the need with a level of detail required to identify a particular good or service provider. For example, a person may know they need to go to the grocery store and get certain items, but that may not be specific enough to know exactly what to purchase.

There are several ways a specific item may be identified from a general listing. Consumers could be presented with a long list of predetermined questions that may be totally irrelevant to the user's needs. Alternatively, they could simply be shown all items that correspond to their original description, but that may prove cumbersome.

As a result, there exists a need for a system that allows users to request items or services in such a manner that the system can identify the correct good or service provider with the minimal expenditure of user time.

### SUMMARY

The disclosed invention allows a user to enter a raw input list 100 of requested products or services and returns a refined list of specific items that may be sent to third parties. This is a multi-step process where the user inputs the raw input list 100 into the system. Once there, the raw input list is first processed through user profile processing 300 to identify specific items or services. Then keyword processing 400 utilizes a dynamically generated list of keywords for further refinement. Secondary processing 500 occurs to see if there are companion products or services that the user may consider purchasing. Once the refined list is completed, it is sent to vendors who return prices for goods or services via the external interface 600.

This process may be adapted for multiple forms of commodities or service providers. The disclosed invention allows a genus of an item or service to be input, allowing the system to output a specific species of the item or service.

### DETAILED DESCRIPTION OF FIGURES

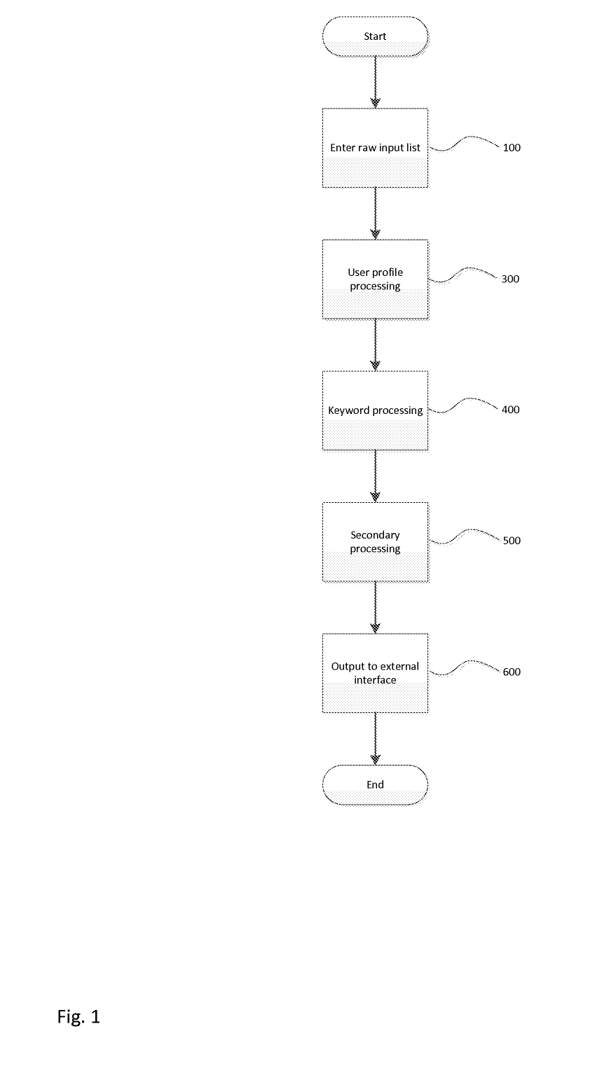

FIG. 1 shows an overview of an exemplary embodiment of the disclosed invention.

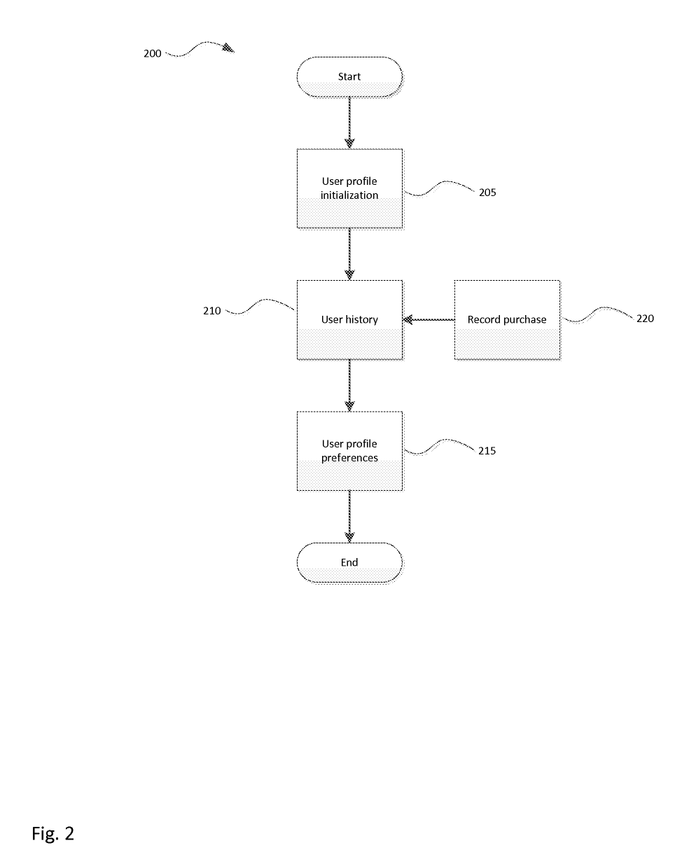

FIG. 2 shows the process of generating a user profile in an exemplary embodiment of the disclosed invention.

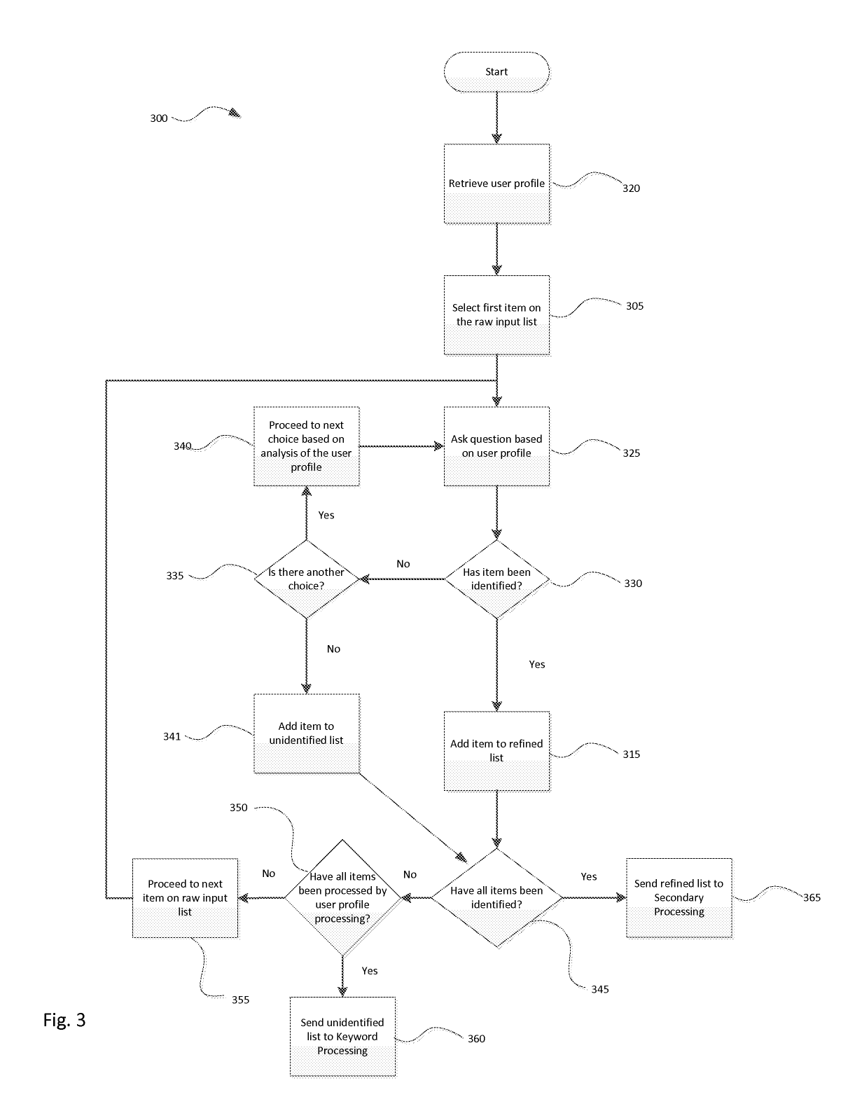

FIG. 3 shows the process of user profile processing in an exemplary embodiment of the disclosed invention.

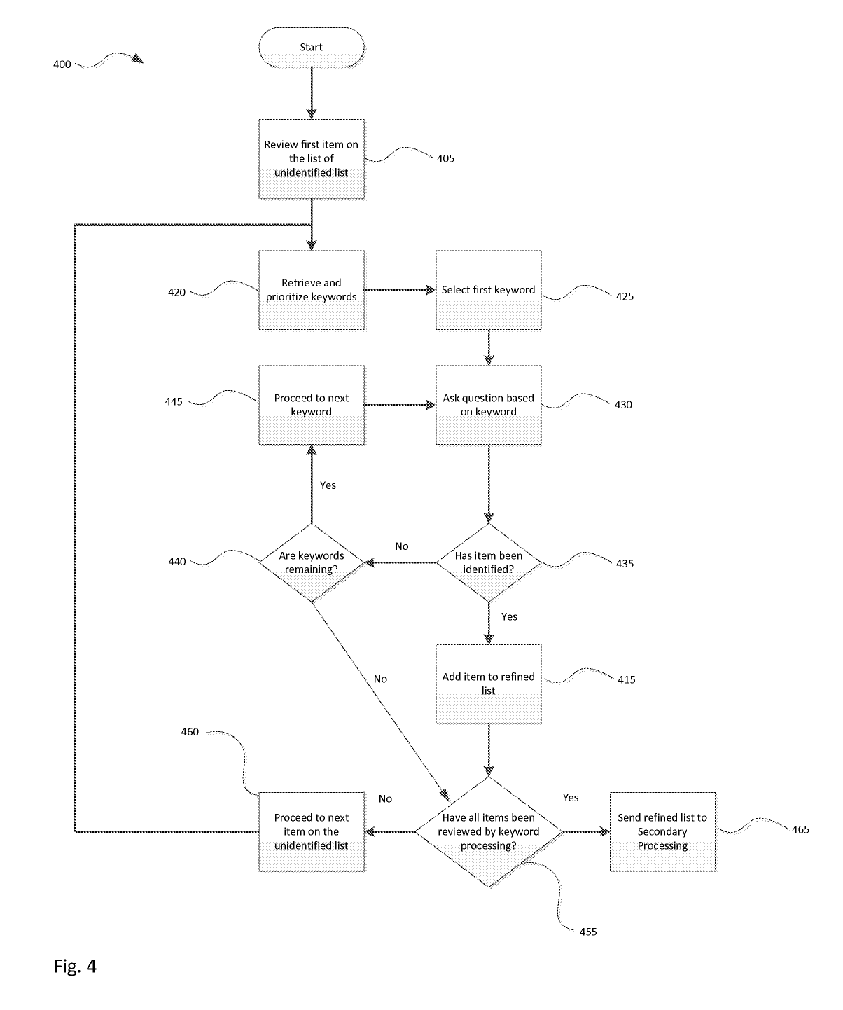

FIG. 4 shows the process of keyword processing in an exemplary embodiment of the disclosed invention.

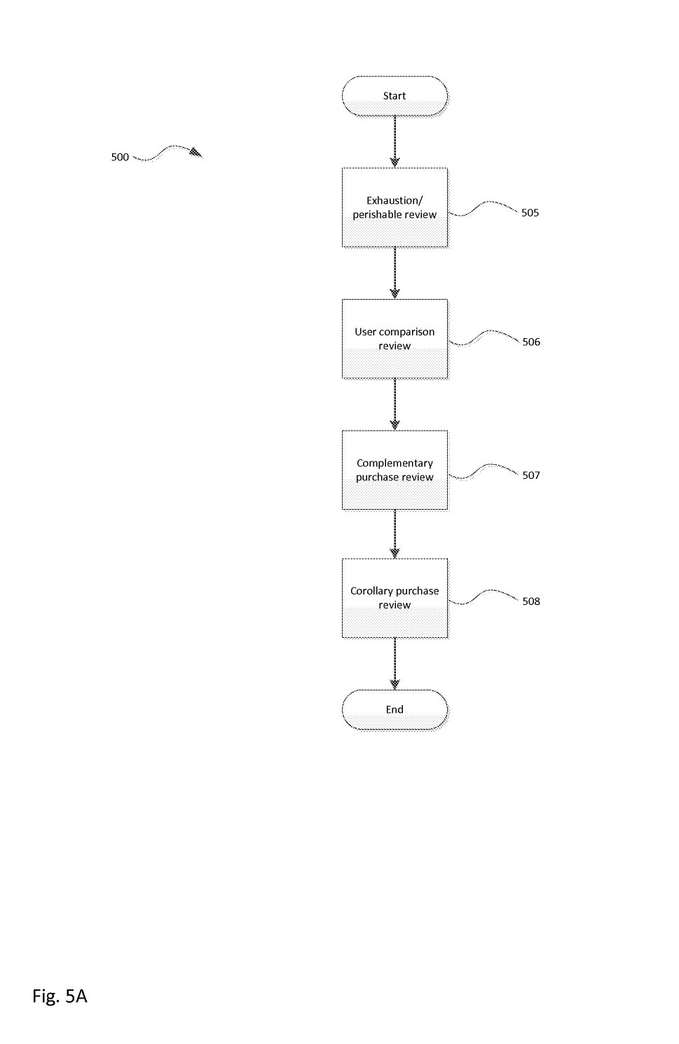

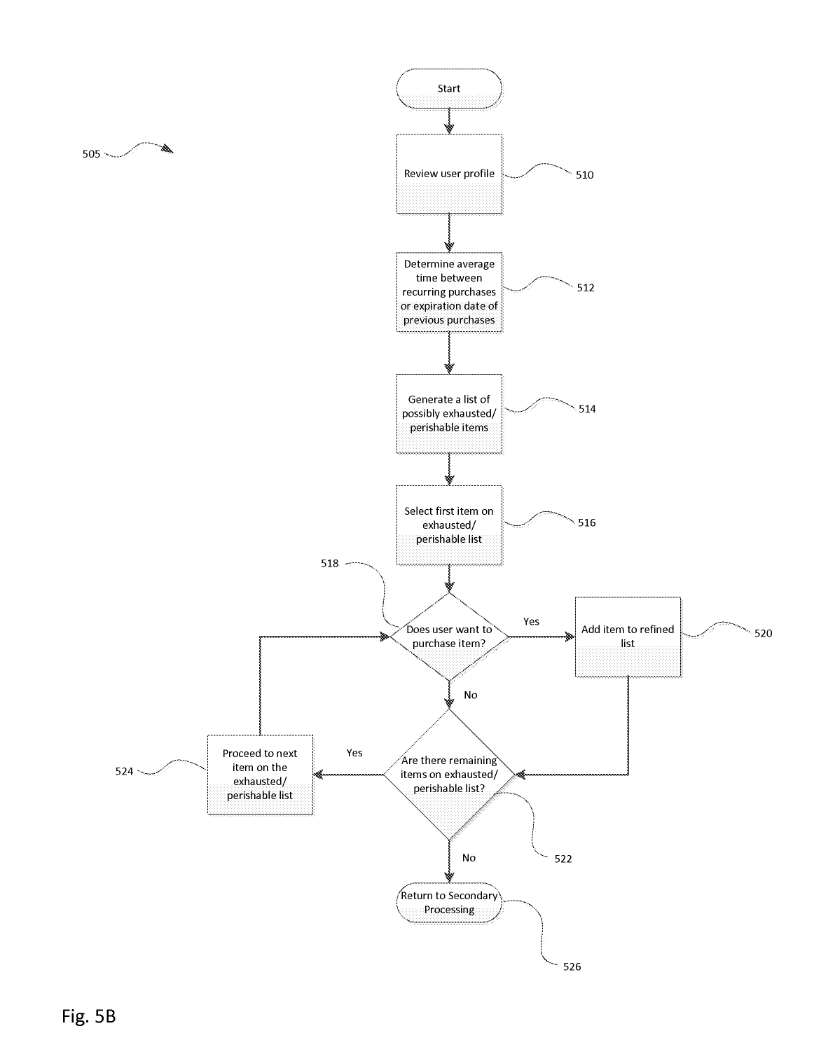

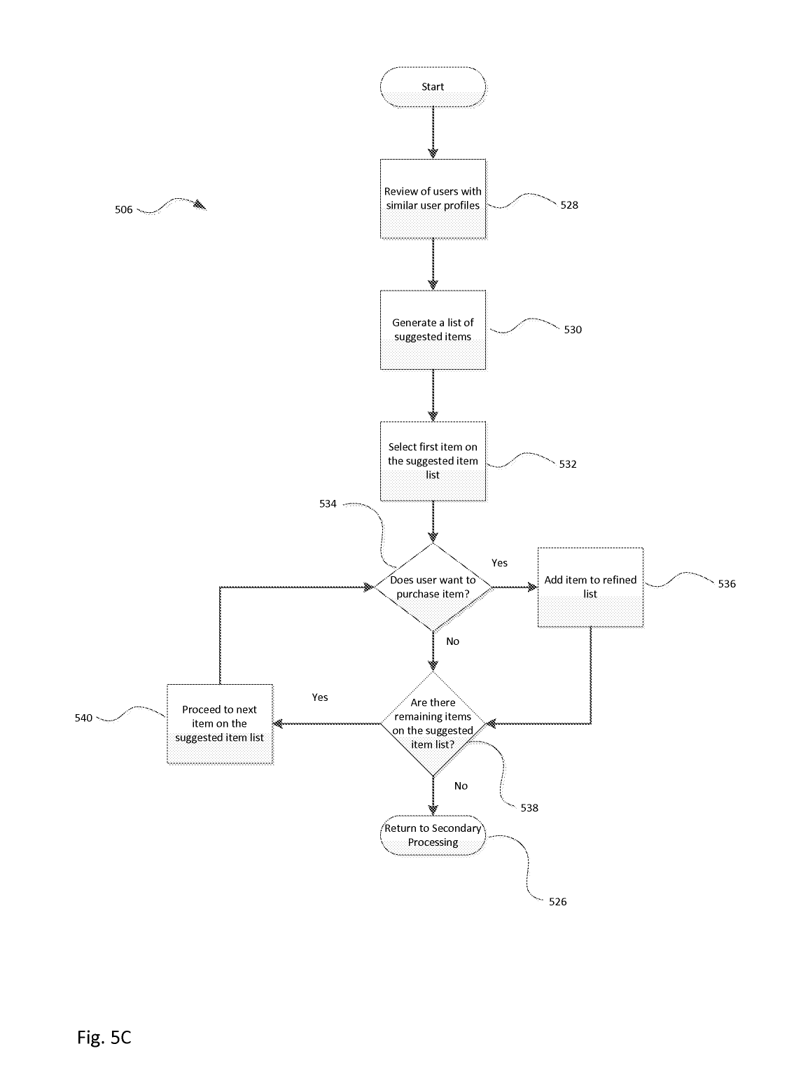

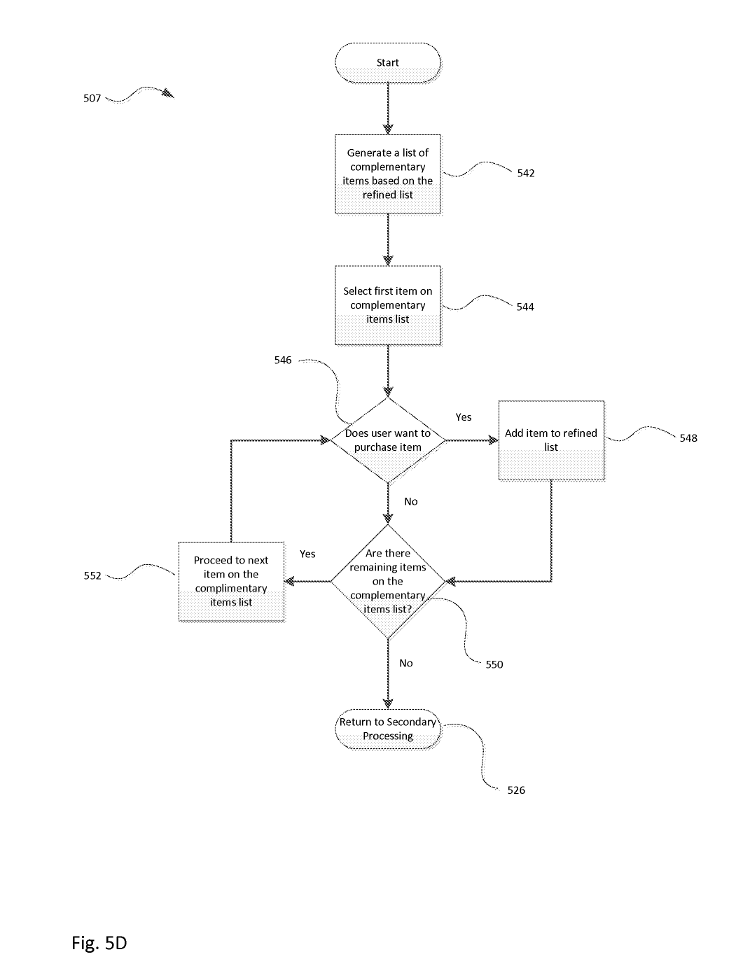

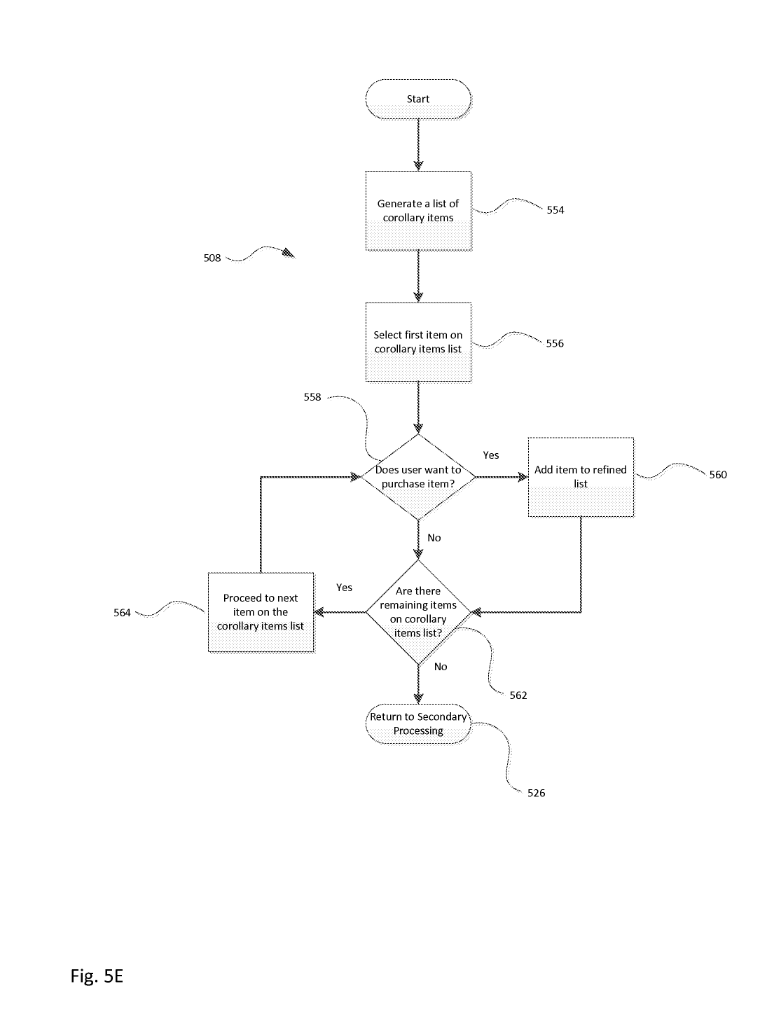

FIG. 5A shows an overview of secondary processing in an exemplary embodiment of the disclosed invention.

FIG. 5B shows the secondary processing of exhaustion/perishable review in an exemplary embodiment of the disclosed invention.

FIG. 5C shows the secondary processing of user comparisons in an exemplary embodiment of the disclosed invention.

FIG. 5D shows the secondary processing of complementary purchases in an exemplary embodiment of the disclosed invention.

FIG. 5E shows the secondary processing of corollary purchases in an exemplary embodiment of the disclosed invention.

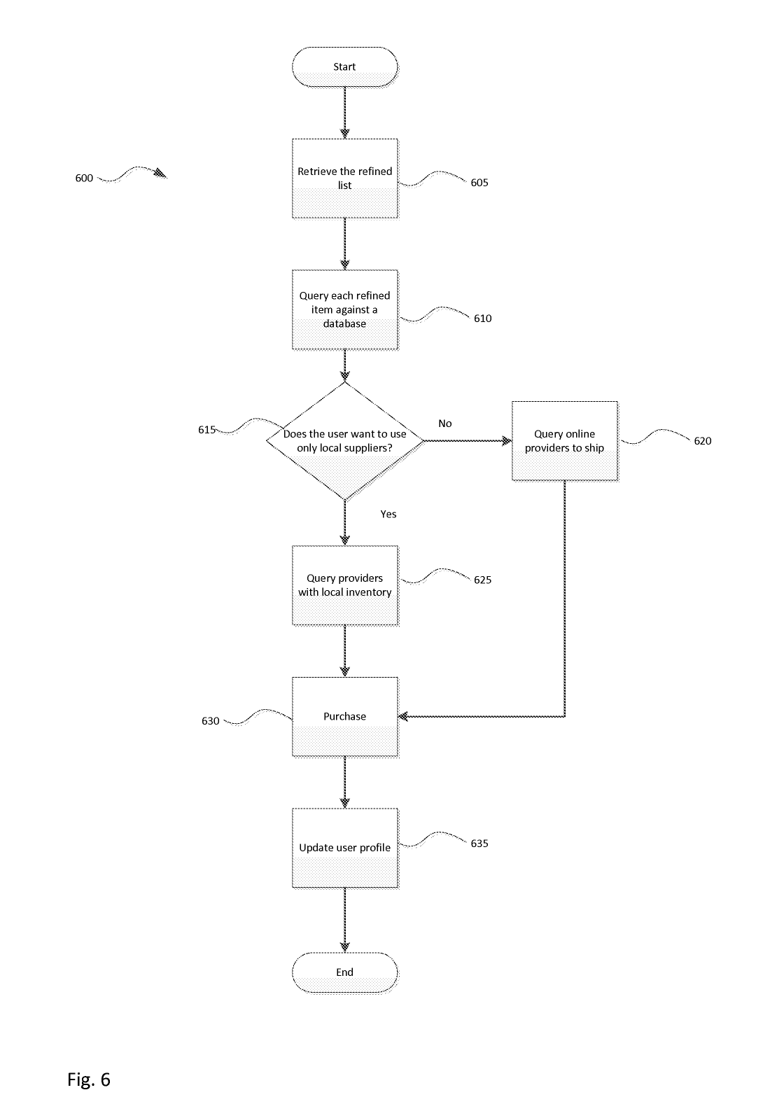

FIG. 6 shows the process of exporting the refined list to vendors in an exemplary embodiment of the disclosed invention.

### DETAILED DESCRIPTION

The disclosed methodology and system allows for the automation of purchases based on minimal input from the user. This is accomplished in several steps. As shown in FIG. 1, the system receives a raw input list 100. Next the raw input list is sent to user profile processing 300, where the raw input list is reviewed against the user's profile. Some of the items on the raw input list may be defined in user profile processing 300. Any remaining unidentified items on the raw input list may be sent to keyword processing 400, where a dynamically generated list of keywords is used to ask questions to assist in identifying the specific product. The resulting list is then augmented by secondary processing 500 to make further additions to the resulting refined list. The refined list is then output to an external interface 600. For illustrative purposes, the exemplary embodiments will involve a grocery list. It is understood that this methodology may be utilized for any other form of commodity or service request.

One of the advantages of the invention is that it provides the user with a refined list of specific items from a raw input list by asking of a minimal number of questions, thereby saving time. When the system achieves a predetermined level of confidence that the specific item has been identified, it stops asking questions, places the item on the refined list, and allows the user to confirm the selection at the end. For the exemplary embodiments, a confidence level of 90% is sufficient for the system to move on to the next item on the raw input list. The specifics of how the confidence level is determined, and the appropriate level of confidence to achieve, may be based on any known system determined by the system designer.

### User Profile Generation

One technique used to help determine the specific items the user is looking for involves the generation of a user profile 200 as shown in FIG. 2. The first time that the system is used by a user, the user profile needs to be initialized 205. The user profile initialization 205 may be accomplished in various ways, including, but not limited to, answering multiple questions related the user and his preferences. These could be very simple questions that establish user's or the user family's demographics. Another way to initialize the user profile is to import previously collected data. The system will also review the user's history 210 over the course of repeated uses of the system. This will allow the system to look back on purchases over a period of time and determine relevant purchasing patterns by recording the purchases 220 made using the invention. This information will also be used to assist in placing items on the refined list in a manner similar to that of the user profile.

The user profile also allows the system to compare the user against other users to see if there are common preferences in the user's demographic, as will be discussed later in the disclosure. Additionally the system may ask if the user has preferences 215, such as locally produced food, organic food, gourmet food, bargain foods, or other articulable classifications. The system may also allow the user to list items to specifically avoid, such as items with MSG or gluten.

For exemplary purposes, the following profile for a user named Allen will be used to illustrate the invention.

| User name | Allen |
|---|---|
| Income Level | $75,000 |
| Statistics of all members of household | Self- 35 year old male |
| | Wife- 33 year old female |
| | Children- 8 year old girl |
| Residence | Houston, Texas |
| Style of food | All |
| (Gourmet, economy, healthy) | |
| Brand preferences | Store brand |
| Store brand, regional brand, national brand | |
| Local food producers | No |
| Preferred stores | K-Grocery Store at 7747 |
| | Kirby Drive |
| Discount necessary to consider alternate store | 25% |

### Initial Input

In an exemplary embodiment, the system receives a raw input list 100 from the user from any form of input device. In the exemplary embodiment, the system will utilize a program (or an “app”) on a smartphone. However, this system may utilize other mechanisms, including, but not limited to, a telephone based system, web based system, touch screen based system, or other technology capable of user interface. The input can be input via text or voice depending on the embodiment.

In the exemplary embodiment, the user may speak a list into the input device, such as, “bread, lunch meat, butter, soda, toothpaste, paper towels, aspirin, yogurt, and ice cream.” While the exemplary embodiment will involve all user requests being input at once, it is understood the same process could occur after each individual input is entered.

### User Profile Processing

As shown in FIG. 3, the system begins user profile processing 300 by retrieving the user's profile 320. The first item on the raw input list is then selected 305. The system will ask a question based on the user profile 325 to look for a corresponding product. Previously purchased items may be presented for the user to select from. If the desired product is identified 330 then it may be placed on the refined list 315. The system then checks to see if all items have been identified 345. If they have all been identified, then the refined list is sent to secondary processing 365. If all items have not been identified 345, then the system checks to see if any of the remaining items on the raw input list have not been though user profile processing 350. If all items from the raw input list have been processed through user profile processing 350, then the unidentified items are then sent to keyword processing 360. If there are unidentified items that have not yet been though user profile processing 350, then the system proceeds to the next item on the raw input list 355 and asks a question based on the user profile 325.

In the event that a product on the raw input list is not identified 330 based on the answer to a question based on the user's profile 325, then the user profile is reviewed to determine if there is another choice 335. If there is another choice 335, then the next choice based on an analysis of the user's profile is selected 340 and another question is asked 325. In the event there are no choices available 335 based on the user's profile, the item is placed on the unidentified list 341. The system then looks to see if all the items have been identified 345 and the process continues as shown above.

In addition to analyzing the user's purchase history in an exemplary embodiment, the user's profile would be referenced to make a decision based on known facts about products and comparisons against users with a similar profile. By referencing the user's profile, the system may also display choices based on what users of a similar demographic have purchased based on the assumption the user would want something similar. The system may also generate choices based on the user's culinary preferences. Examples could include gourmet foods, discount foods, regional foods, etc.

Going back to the exemplary profile, Allen enters his list 100, asking for bread, lunch meat, butter, soda, toothpaste, paper towels, aspirin, yogurt, and ice cream. The system now begins the process of identifying specific items. The user profile is retrieved 320. The first item on the list selected is bread 305. The first question may be based on the fact that the user has only purchased two types of bread in the past: Acme Whole Wheat Bread and Big Tex Texas Toast 325. Both items may be displayed and Allen will select the one he wants, if either of them. Allen selects Acme Whole Wheat Bread 330. Acme Whole Wheat Bread is now added to the refined list 315. In the event that his history showed that he had only purchased Acme Whole Wheat Bread in the past; then the system would have placed Acme Whole Wheat Bread on the list by default, assuming the predetermined level of confidence was achieved.

Since all items have not yet been identified 345, and all the items have not yet been processed by user profile processing 350, the next item on Allen's list is selected 355. When going to the next item on Allen's list, the system shows lunch meat he has purchased in the past 325, but Allen cannot identify the item he wants initially 330. The system then accesses the user's profile to determine the next appropriate choice based on the analysis of the user's profile 340. The system may return a series of possible choices based on the use's profile 325, and Allen will make identify the item he wants 330. In this case, Allen will select Hamshire Fields Roast Beef as that was supplied to him based on his user profile.

The system proceeds to the next item on the raw input list 355. The system sees that Allen has never purchased butter with this system, so there is no history in the user profile to refer to in order to ask a question 325. Since there is no item to identify 330, the system will initially assume there is another choice 335 and look for a choice based on the user's profile. In the absence of looking at the user's pregenerated preferences, the system will compare the user's profile against other known users with similar profile and/or review applicable items to see if they correspond to the user's buying choices 340. The system may ask a question 325 based on the analysis of the user's profile 340, and the user will make a selection 330. In this case, Allen chooses Lots of Ponds Butter. This information may be recorded in the user profile 200 to provide a record for the system to reference when looking at the user's history.

For the remainder of this example, it will be assumed that no more items can be identified by user profile processing 300.

### Keyword Processing

If the user profile processing 300 does not identify the specific product, the system moves on to keyword processing 400 shown in FIG. 4. Keyword processing involves a series of dynamically generated questions based on keywords to identify the specific item from the raw input list. Unlike a static listing of questions to ask, this process will retrieve an updated list of refinement keywords on a regular basis to tailor a user's choices for each item. The keywords used may be generated by the system or may be obtained from a third party.

Keyword processing begins by accepting the list of previously unidentified items 405 from the user profile processing. Keywords are retrieved and prioritized 420 based on the unidentified items. The first keyword is selected 425 and a question is asked based on the keyword 430. If the item has been identified 435 it is then placed on the refined list 415. If the item has not been identified 435, the system sees if there are any keywords remaining 440. If there are keywords remaining 440, then the system proceeds to the next keyword 445 and asks a question based on the keyword 430, and the process begins again. Once the item has been identified 435 with a predetermined level of confidence, the item is added to the refined list 415. For example, if the system has 90% confidence that a particular item has been identified, then it will stop asking questions, and place the item on the refined list 415. If all the items have been processed by keyword processing for 455, then the refined list is sent to secondary processing 465. If there are unprocessed items remaining 455, then the next item on the unidentified list is selected 460. Once all the items have been reviewed by keyword processing 455, then the refined list is sent to secondary processing 465.

If an item in keyword processing goes through sufficient iterations to exhaust the keywords 440 without being identified, the item remains on the unidentified list. In that event, there are several options. One option would be to simply display the most popular choices in the category of good or service requested. Another option would be to have the raw input associated with the unidentified item displayed with the refined list at the conclusion of the processing to assist the user in locating the item by an alternative means.

Using Allen as an example, the next item on his list is soda 405. It will be assumed that there have been so many varying purchases for soda that it would be impossible to select one without more information. The system would need a 90% level of certainty before placing an item on the refined list in the exemplary embodiment. The system retrieves and prioritizes the keywords 420 applicable to soda. The system may determine the first keywords for soda would be clear soda or color soda 425. Allen may select color soda based on the question asked 430. Since this does not allow the item to be specifically identified 435, and since there are keywords remaining 440, the next keyword is selected 445 and another question is asked 430. The system may determine the next question for color soda would be brown or yellow 430. If Allen picks brown, the system may determine that the item cannot be identified 435, there are keywords remaining 440, select the next keyword 445, and ask the next question 430. In this case the next question would be if the soda is sweet or cinnamon 430. If the user selects cinnamon, and at that point the system determines only one brown cinnamon soda has previously been purchased, it can say with reasonable certainty that soda has been identified 435. In this case, the only brown cinnamon soda Allen has ever purchased is Classical Cola. The system now places Classical Cola onto the refined list 415. The system will look to see if there are remaining items to be reviewed by keyword processing 455. If there are items remaining, then the next item on the unidentified list will be reviewed 460 in the same manner. If all the items have been reviewed by keyword processing 455, then the refined list is sent to secondary processing 465.

Altering the facts of the previous example, if Allen selected sweet soda in response to the question about sweet versus cinnamon 430, and there were multiple choices such that 90% confidence could not be achieved, the item would remain unidentified 435. The system would then determine if there was a keyword remaining 440 and if so, select the next keyword 445 and ask a question based on the next keyword 430. This is because without additional questions, there would be a less than 90% chance that the soda selected by the system would be correct. This process will keep repeating until the desired level of confidence is achieved. In an alternative embodiment, if the product remains unidentified, the system may display the most popular sections for the user to choose from.

This process is repeated with toothpaste, paper towels, aspirin, yogurt, and ice cream. In the end Allen will purchase Acme Whole Wheat Bread, Hamshire Fields Roast Beef, Lots of Ponds Butter, Classical Cola, Wave Toothpaste, Lumberjack Paper Towels, Vidal Aspirin, Cannon Lemon Yogurt, and White Alarm Peaches and Cream Ice Cream based on user profile and keyword processing.

It is understood that while keyword processing in this exemplary embodiment is performed after user profile processing, it may also be performed independently of any other form of identifying process to achieve comparable results.

### Secondary Processing

Once the refined list is generated, it is sent to secondary processing 500. Secondary processing 500 is an umbrella term for any additional questions to be asked to further develop the refined list. Secondary processing 500 is a series of processes that may occur in any order, or not at all, and still be within the scope and spirit of this invention. In an exemplary embodiment shown in FIG. 5A, secondary processing includes exhaustion/perishable review 505, user comparison review 506, complementary purchase review 507, and corollary purchase review 508.

First is the exhaustion/perishable review 505 as shown in FIG. 5B. This is a process where the average time needed for a product to be exhausted through normal use, or by expiration date, is determined. The system reviews the user's profile 510 over a predetermined period to determine the average time between recurring purchases or if previously purchased items have exceeded the item's expiration date 512. The system will then generate a list of possibly exhausted/perishable items 514. This determination may be based on any form of analysis know to those skilled in the art to make the determination of what items should be exhausted or past their expiration date. The system will then select the first item on the exhausted/perishable list 516 and prompt the user to see if he wants to purchase the item 518. If the user wants to purchase the item 518, it is placed on the refined list 520. If there are items remaining on the exhausted/perishable list 522, then the next item on the exhausted/perishable list is selected 524 for the user to be prompted to see if he wants to make a purchase 518. If the user does not wish to purchase the item 518, then the system looks to see if there are items remaining on the exhausted/perishable list 522, and if so, the next item on the list is selected 524. If there are no items remaining on the exhausted/perishable list 522, then the system returns to secondary processing 526.

For example, if the system knows that a loaf of sandwich bread is purchased every ten days by the user, then it may prompt the user to purchase a new loaf of sandwich bread if more than ten days have passed since sandwich bread was last purchased. Another example would involve something that may not be consumed as quickly, such as over-the-counter medicine. If aspirin loses potency in one year, and the last purchase of aspirin was over a year ago, it may ask if the user wants to purchase aspirin.

In the Allen example, Allen's profile is reviewed 510. The system has determined that he purchases a box of cereal bars every two weeks 512. If cereal bars were last purchased three weeks ago, then they would be put onto the perishable review list along with any other applicable items 514. The system now selects cereal bars 516, and will ask Allen if he wants to purchase them 518. If Allen agrees, then they are put on the refined list 520. If there are other items on the perishable list 522, then next item is selected 524 and Allen will be asked about the next item 518. This process is repeated until the exhaustion/perishable list has been exhausted.

Another item Allen has previously purchased is milk. The expiration date is determined based on when it was purchased 512, and it will be put on the perishable list 514 if the expiration date has passed. Allen will then be prompted to purchase milk as in the previous example 518, and the process continues from there as before.

The next form of secondary processing involves comparisons with other users 506 as shown in FIG. 5C. The system will compare the user's profile against others with a similar profile 528. The system will look for coloration between the other user's purchase histories to identify patterns and generate a list of suggested items 530 based on what is already on the user's refined list. The first item on the suggested list is selected 532 and the user is prompted to see if he wants to purchase the suggested item 534. If the user chooses to purchase the suggested item 534, the suggested item is added to the refined list 536. If there are items remaining on the suggested list 538, then the next item is selected for review 540. In the event the user does not want to purchase the suggested item 534, then the system looks to see if there are items remaining on the suggested list 538 and if not, the next suggested item is reviewed 540. Once all the suggested items are reviewed 538, then it returns to secondary processing 526.

In the Allen example, Allen purchased Acme Whole Wheat Bread and Classical Cola. The system would look to other users with a similar profile 528 and see if there are suggested items 530. In this example, users who make purchases similar to Allen also purchased Captain Hook Creamy Peanut Butter 530. The system selects this item 532 and prompts Allen to see if he wants to buy that item 534. If he agrees, then the item is put on the refined list 536. If there are still items remaining on the suggested list 538, then the next item is selected and Allen will be prompted again 534. Once there are no other items on the suggested list 538, then the list returns to secondary processing 526.

Another form of secondary processing involves complementary purchases 507 as shown in FIG. 5D. Once the refined list is created, the system can look for complementary items based on the refined list 542. The first item on the complementary list is selected 544 and the user is prompted if he wants to purchase the complementary item 546. If the user wishes to purchase the complementary, item 546, then it is added to the refined list 548 and if there are remaining complementary items 550 the next complementary item is selected 552, prompting the user for a decision on another complementary item 546. Once there are no further complementary items remaining 550, the refined list returns to secondary processing 526.

Going back to the Allen example, Allen decides to buy cake mix, and it is placed on the refined list 542. Cake mix has complementary purchases as cake mix requires milk, eggs, and butter, which the system places on a complementary list 542. The first item on the complementary list is selected 544, and Allen will be prompted to see if he wants to purchase the complementary item 546. If he does, it is placed on the refined list 548, and if there are items remaining on the complementary list 550, then the next complementary item is selected 552, and Allen will be prompted to see if he wants to purchase that complementary item 546. Once the complementary list has been reviewed 550, then the system returns to secondary processing 526.

Complementary items may be determined based on a predetermined set of criteria or learned by the system as it looks to the purchases made by other users. There are various other simple associations that can prompt complementary purchases. Users who purchase bread and lunch meat may buy condiments, such as mustard or mayonnaise. The system would prompt the user to see if he wanted to purchase those items. Another example is dental floss, which may be bought at the same time as tooth paste.

Next the system may look for corollary items 508, as shown in FIG. 5E. Once the refined list is created, the system can generate a list of corollary items based on the refined list 554. Corollary items would be those that would suggested assuming a relationship between a particular item being purchased and lifestyle choices of a user. The first item on the corollary list is selected 556 and the user is prompted if he wants to purchase the corollary item 558. If the user wishes to purchase the corollary item 558, then it is added to the refined list 560. If there are remaining corollary items 562 the next corollary item is selected 564, prompting the user for a decision 558. Once there are no further items remaining on the corollary list 562, the refined list returns to secondary processing 526.

The system may then look for items with a correlation to lifestyle choices. This may help the user by identifying items that would otherwise not be considered by the user. Returning to Allen's purchases, Allen may decide to purchase tofu. The system will see tofu and see if that correlates to any known trends, such as health consciousness. If it does, then it will generate a series of corollary items 554. At that point, the system may suggest additional products to purchase, such as fruits and vegetables. Additionally, it may use this information to influence the earlier choices for requested items, such as butter, bread, etc. The first item on the corollary list will be selected 556 and Allen will be prompted to see if he wants to purchase the item 558. If he does, then the item is added to the refined list 560, and if there are items remaining on the corollary list 562, then the next corollary item is selected 564 and the user is again prompted for a purchase 558. Once all the corollary items have been reviewed 562, the system returns to secondary processing 526.

As a result of this processing, a more defined and robust list of purchases can be created from the original raw input list. The initial list of bread, lunch meat, butter, soda, toothpaste, paper towels, aspirin, yogurt, and ice cream has developed into a refined list of Acme Whole Wheat Bread, Hamshire Fields Roast Beef, Lots of Ponds Butter, Classical Cola, Wave Toothpaste, Lumberjack paper Towels, Vidal Aspirin, Cannon Lemon Yogurt, and White Alarm Peaches and Cream Ice Cream, fresh fruit, and dental floss.

While a specific ordering of steps as been disclosed in this specification, it is in no way meant to be limiting. The disclosed steps may be taken in any order to achieve the intended result. Further, steps may be omitted and still be within the scope and spirit of the invention. For example, the entire process may be accomplished using keyword processing alone.

### Macros

Macros may also exist in the system. Macros may supply a pregenerated raw input list 100 to save user time. For example, the request may be “get ingredients for a crawfish boil”. The system will then look to see what is necessary for a crawfish boil. In this example, crawfish, new potatoes, crawfish boil mix, corn, salt and pepper are needed. The macro can generate a raw input list to allow processing as previously described in this specification. In an alternate embodiment, the macro can populate the refined list directly, and the user can modify or delete as needed. Further, the system may ask questions based on the macro, such as determining how many people will be eating at the crawfish boil.

Another macro may be “I need to make dinner tonight”. At that point, the system may show what has been purchased recently so the user can see what options are available. The system may also be able to make some basic suggestions that will help the user decide what to purchase for dinner.

This listing of possible macros is not in any way meant to be limiting. Any set of pre-definable shortcuts may be included within the scope of this invention.

### External Interface

The refined list is finalized and then output to the external interface 600 as shown in FIG. 6. The system retrieves the refined list 605 and queries each item on the refined list against a database 610. Databases may include information from online providers and those providers who also have physical stores. The system can be directed to search all online providers or only those with local suppliers 615. If a local supplier is not selected, then online providers are reviewed 620. If local suppliers are selected, then only providers with a local presence are queried 625. Regardless of which are queried, the query is sent to the provider for purchase 630 if the user chooses to complete the purchase. If the purchases are made, the user's profile is appropriately updated 635.

Additionally, the system may alert the user to discounts from providers other than the one he selected. The system can be designed to alert the user if discounts of a particular amount for a good are available and alert the user to these lower prices. While a predetermined level of discount may be input by the user, in his user profile, the system may determine over time that there is level of discount that would be necessary for the user to consider going to an alternative supplier.

Returning to the example of Allen, the refined list is retrieved 605. The refined list is now queried against a database 610 to identify where the items may be purchased. They system will now ask if Allen wants to use a local supplier 615. Allen chooses a local supplier, and the system queries local suppliers for their inventory 615. If the query returns a result Allen likes, he can purchase the items 630. His user profile is then updated 635. In the event he wanted to use a non-local supplier 615, then the non-local, or online supplier, would be queried 620 before the purchase 630.

Assuming Allen stayed with the local supplier, then the system in an exemplary embodiment may also alert him to sales beyond his typically supplier. The system reviews the prices at his preferred store (K-Grocery Store), but it has also reviewed prices at other stores. The system has been instructed not to alert Allen to savings unless the discounts are by more than 20%. In this instance, there may be no applicable savings. However, the T-Mart down the street may be selling bread at 50% off. In that case, Allen is alerted, and he may alter his shopping plans accordingly.

Another feature allows the user to look for a good or service when out of his normal area. By using his location, he can make requests through the system to local stores instead of his preferred store. This allows him to utilize the system whether he wants to know what is available within a short distance or if he is in an unfamiliar area and does not know where to locate the items he wants to purchase.

If the items are available through a physical store, such as a grocery store, the system may also assist the user in locating the items in the store. It may use any known method of guiding an individual to the items known to those skilled in the art. In the exemplary embodiment, the system may use cell tower triangulation, GPS, Wi-Fi locations, and other reference points to determine where a product is located. In an exemplary embodiment, the user enters the grocery store with his refined list already generated. Once the user is within proximity to the store, the system detects his location and determines the optimum route through the store. This route may be based on several factors. One may be to go through the store in one pass, saving time. Another setting may be to pick up cold items last (such as frozen foods or ice cream). Another setting may be to stop by the deli counter and place an order allowing it to be filled while the user gets other groceries.

Additional options include e-mailing the store in the event they provide a preparation service. Also, coupons may be generated for use at the store. The refined list may also be sent to other users so that one member of the family can make the list for the other one to receive.

### Alternative Applications

While the type of items processed and sent to the vendors may be in different categories (food, clothing, auto parts, etc.), the process remains the same and within the scope of the invention.

Commodities other than food may be identified and selected by this system. Garden supplies may be used in the exemplary embodiment which will only use keyword processing. If the user asks for a brass nozzle, the system will look to keywords to determine what type for nozzle is requested. Is the nozzle for home or industrial use? Does the nozzle need to have a mist setting or a sprinkler setting? By asking these questions, the system can narrow, down the requested item quickly. Additionally, pictures of the item may be provided to assist in the product selection. Once the item is identified, then the system looks for the best prices. The system can provide the price from local vendors or from online suppliers as previously described.

The disclosed invention may also be adapted for service providers. In an alternate embodiment, the system may be asked to find a painter for example. The system will look to see what keywords or criteria are associated with painting a room. It may determine that room dimensions, number of coats of paint, supplier of the paint, and when the project must be completed by are necessary pieces of information. These criteria may be built organically over time through keywords, prior user interactions with the invention, inputted manually by the developer, gleaned in real time through web searches, etc. The system then has the user supply the needed information. A sample e-mail may read as follows:
“I am requesting a bid on painting a 20×30 room with 8 foot ceilings in my home in Houston, Tex. I would like two coats of paint applied to the walls with an interior latex paint that you will supply. This job must be accomplished by this Friday. I will be available at my home after 1:00 PM tomorrow if you need to come by for an estimate. A picture of the room is attached. Please respond within 24 hours of this e-mail.”

From that point, a list of possible contractors may be drawn up. An e-mail may be sent to them with the needed information. After receiving this e-mail, a service provider can then contact the user with all the necessary questions answered so that the providers can make a bid. These bids may be reviewed by the user to select the best answer.

Service providers may utilize user profile processing, keyword processing, and secondary processing without departing from the scope and spirit of the invention.

Therefore, the foregoing is considered illustrative only of the principles of the invention. Further, since numerous modifications and changes will readily occur to those skilled in the art, it is not desired to limit the method and system to the exact steps and operation shown and described, and accordingly, all suitable modifications and equivalents may be resorted to, falling within the scope of the method.

1. A method for identifying an item or service, comprising:
accessing a raw input list comprising at least one or more genus of item or service,
retrieving a plurality of keywords based on one of said at least one or more genus of item or service,
asking questions based on said plurality of keywords for identification of a species of item or service,
identifying said species of item or service based on answers to said questions, and
placing said species of item or service on a refined list.

2. The method of claim 1, wherein identifying said species of item or service based on said answers to said questions occurs when a predetermined level of confidence has been reached.

3. The method of claim 1, further comprising:
repeating said method until all of said at least one or more genus of item or service has been processed by said method.

4. The method of claim 1, further comprising:
retrieving a user-generated profile, and
asking profile based questions based on said user-generated profile for identification of said species of item or service.

5. The method of claim 4, further comprising:
identifying a plurality of secondary user-generated profiles based on similarities with said user-generated profile,
retrieving secondary user purchase histories of said plurality of secondary user-generated profiles,
determining statistically common purchases between said secondary user purchase histories,
asking questions based on said secondary purchase histories for identification of said species of item or service,
identifying said species of item or service based on answers to said questions based on said purchase histories, and
placing said species of item or service on said refined list.

6. The method of claim 1, further comprising:
retrieving a user purchase history,
asking questions based on said user purchase history for identification of said species of item or service,
identifying said species of item or service based on answers to said questions based on said user purchase history, and
placing said species of item or service on said refined list.

7. The method of claim 6, further comprising:
reviewing said user purchase history to identify recurring purchases of said species of item or service,
calculating an interval between said recurring purchases of said species of item or service, and
prompting user to purchase said species of item or service if the last purchase of said specific item or service is beyond said interval between said recurring purchases of said species of item or service.

8. The method of claim 1, further comprising:
identifying complementary items to said species of item or service on said refined list,
prompting user for purchase of said complementary items, and
placing said complementary items on said refined list.

9. The method of claim 8, further comprising:
identifying a plurality of secondary user-generated profiles based on similarities with a user-generated profile,
retrieving secondary user purchase histories of said plurality of secondary user-generated profiles,
determining statistically common purchases between said plurality of secondary user purchase histories,
asking questions based on said plurality of secondary purchase user histories,
identifying complementary items based on answers to said plurality of questions based on said user purchase histories, and
placing said at least one service on said refined list.

10. A system for identifying an item or service, comprising:
an input device capable or receiving at least one or more genus of an item or a service, and
a database connected to said input device, wherein said database comprises:
a dynamically generated list of keywords associated with said genus of an item or service, allowing identification of a species of an item or service.

11. The system of claim 10, wherein identification of a species of item or service requires minimal input form a user.
